(19) United States
(12) Patent Application Publication
(10) Pub. No.: US 2026/0267810 A1
(43) Pub. Date: Sep. 10, 2026

(54) RECONFIGURABLE PACKET DIRECT MEMORY ACCESS TO SUPPORT MULTIPLE DESCRIPTOR RING SPECIFICATIONS

(71) Applicant: Intel Corporation, Santa Clara, CA (US)

(72) Inventors: Shih-wei Roger Chien, Hsinchu (TW); Gerald Alan Rogers, Chandler, AZ (US); Cunming Liang, Shanghai (CN); Stephen T. Palermo, Chandler, AZ (US)

(21) Appl. No.: 18/846,997

(22) PCT Filed: Apr. 1, 2022
(86) PCT No.: PCT/CN2022/084928

§ 371 Date: Sep. 13, 2024

(51) Int. Cl. G06F 13/28; G06F 12/0811; G06F 12/0815

(52) U.S. Cl. CPC G06F 13/28; G06F 12/0811; G06F 12/0815; G06F 2212/152; G06F 2213/2802

(57) ABSTRACT

A hardware component for implementing packet descriptor handling. Packet direct memory access (DMA) circuitry for packet descriptor handling, includes: a system connect interface to a memory device, the memory device used to store packet descriptor rings; direct memory access (DMA) engine to directly read and write to the memory device over the system connect interface, bypassing a host processor; first descriptor ring control engine to transform a first packet descriptor that refers to a packet data and that has a first packet descriptor format to a second packet descriptor that refers to the packet data and has a second packet descriptor format, wherein the first and second packet descriptors are stored in the memory device; and second packet descriptor ring control engine to transform packet descriptors having the second packet descriptor format to packet descriptors with a third packet descriptor format.

### TECHNICAL FIELD

Embodiments described herein generally relate to data communication systems and in particular to a reconfigurable packet direct memory access mechanism to support multiple descriptor ring specifications.

### BACKGROUND

Currently, network cards transmit and receive data packets. As network use grows and additional systems come online to serve more data to more end users, data communication services need to become faster and more efficient. At the network card level, effective and deterministic packet processing is needed to increase throughput in a network.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a schematic diagram illustrating an operating environment, according to an embodiment;

FIG. 2 is a schematic diagram illustrating how a packet is transmitted and received, according to an embodiment;

FIG. 3 is a schematic diagram illustrating how a packet is transmitted and received using direct memory access (DMA), according to an embodiment;

FIG. 4 is a schematic diagram illustrating an operating environment, according to an embodiment;

FIG. 5 is a block diagram illustrating various embodiments of a packet DMA circuitry, according to embodiments;

FIG. 6 is a block diagram illustrating components of a packet DMA circuitry, according to an embodiment;

FIG. 7 is a block diagram illustrating data and control flow for descriptor format conversion, according to an embodiment;

FIG. 8 is a block diagram illustrating a descriptor ring control engine, according to an embodiment;

FIG. 9 is a flowchart illustrating a method for packet descriptor handling, according to an embodiment; and

FIG. 10 is a block diagram illustrating an example machine upon which any one or more of the techniques (e.g., methodologies) discussed herein may perform, according to an example embodiment.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

Networks may use different networking interface hardware. Each type of interface hardware may have corresponding data structures and handling behavior to represent network traffic over the particular interface. Data structures called descriptors are used to describe a packet's location in memory, its length, and other aspects of the packet, the network used to transmit or receive the packet, and other control and status information. Although referred to as “descriptors,” it is understood that any data structure that is used to identify the location of data in memory along with other control flags, may be referred to as a descriptor and may be used with the implementations described herein.

In a simple illustrative example, when a packet is to be sent, a device driver places the packet in host memory and stores a descriptor in a data structure. The descriptor includes the address of the packet in host memory, the data field length or size, and other information. The network hardware reads the descriptor and then obtains the packet from memory based on information obtained from the descriptor. The network hardware then transmits the packet contents over the network. On receipt of a packet over the network, the network hardware writes a descriptor and stores the packet's contents in the memory location in the descriptor. The device driver is able to retrieve the packet contents from host memory using the address stored in the descriptor.

Descriptors may be stored in contiguous memory using a data structure, such as a cyclic ring, a cyclic queue, or a buffer. Descriptor rings store descriptors in a cyclic ring or cyclic buffer. When a packet arrives over the network, the network hardware stores a descriptor in a receive descriptor ring.

There are a limited number of entries in a descriptor ring. Thus, if the receive descriptor ring is full, or no buffers are available, packets are dropped, resulting in the sender needing to retransmit. Similarly, when a packet is transmitted, a transmit descriptor ring is used to store descriptions of the transmit packets. If the transmit descriptor ring is full, then the packets are discarded. The sender will have to resend the packet.

When a network appliance uses varying network interface hardware, the appliance has to support distinct descriptor formats for each network interface. The network interfaces may be virtual, which add more complexity because the integrity of the virtual networks need to be maintained. For instance, there are many different formats of descriptor rings, especially in virtualized environments in which there are also different kinds of virtual network interfaces using different formats of descriptor rings, such as Virtio (i.e., v0.95, v1.0, v1.1, and other versions). Further, virtual networking standards may evolve and legacy formats may need to be supported. Maintaining compatibility among different descriptor ring formats is necessary to provide efficient and reliable communications.

Software can be extended to address descriptor compatibility; however, a software solution does not provide sufficient performance and is inefficient because the overhead involved consumes precious CPU cycles. Designing hardware circuitry to offload or acceleration packet transmission is also difficult. Because of the hardware design complexity and hardware being a fixed resource, it is difficult to design hardware that can scale to support multiple formats at once with fixed processing logic for handling descriptor rings.

What is needed is a mechanism to maintain compatibility among multiple descriptor and descriptor ring specifications while maintaining high bandwidth and low latency network performance. The systems and mechanisms described herein provide on-the-fly real-time conversions in order to support multiple descriptor formats and descriptor ring specifications. While many of the examples are described in the context of packet transmission, it is understood that the mechanisms may also be applied to generic data movement between threads or virtual machines, for instance.

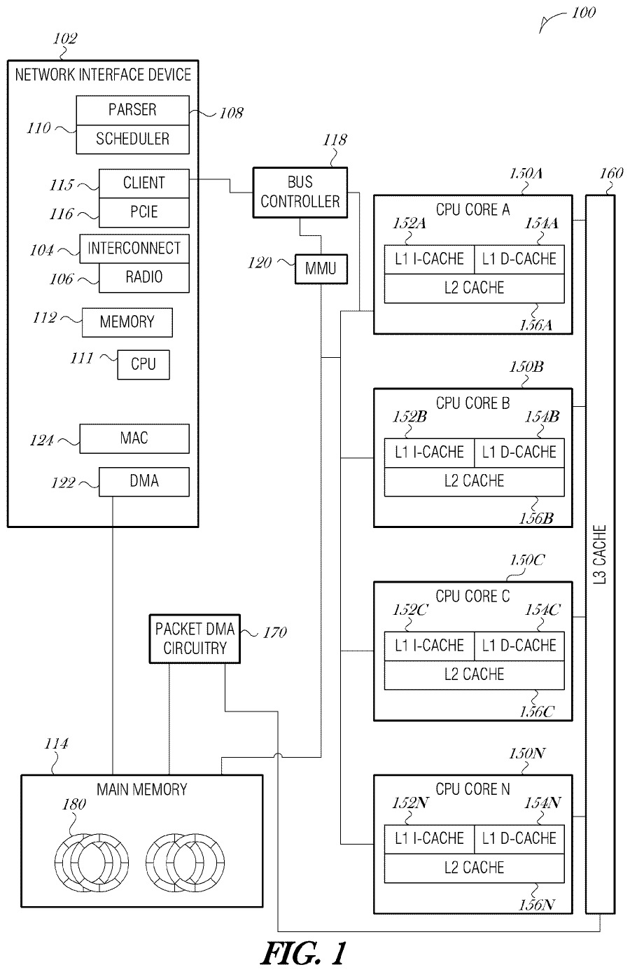

FIG. 1 is a schematic diagram illustrating an operating environment 100, according to an embodiment. The operating environment 100 may be a server computer, desktop computer, laptop, wearable device, hybrid device, onboard vehicle system, network switch, network router, or other compute device capable of receiving and processing network traffic. The operating environment 100 includes a network interface device (NID) 102. The NID 102 includes electronic circuity to support the data link layer with the physical layer. In particular, the NID 102 is able to receive data using an interconnect 104 or radio 106. The interconnect 104 is arranged to accept signals over a physical media, where the signals are arranged into some supported L2 framing, and interpret the incoming signal stream as a stream of bits organized into L2 units called “frames.” The interconnect 104 may be an Ethernet port, for example. The radio 106 is able to send and receive radio frequency (RF) data and is used to communicate over wireless protocols, such as Wi-Fi, Bluetooth, Zigbee, cellular communications, and the like. Other types of communication interfaces may be supported by NID 102, such as Gigabit Ethernet, ATM, HSSI, POS, FDDI, FTTH, and the like. In these cases, appropriate ports may be provided in the NID architecture.

The NID 102 includes circuitry, such as a packet parser 108 and a scheduler circuit 110. The packet parser 108 and the scheduler circuit 110 may use NID memory 112 or main memory 114 for various operations such as queuing packets, saving state data, storing historical data, supporting a neural network, or the like.

The NID 102 also includes a direct memory access (DMA) circuit 122 and media access control (MAC) circuit 124 (also referred to as medium access control (MAC)). The DMA circuit 122 may be used to access main memory 114 through a fabric (e.g., Intel® On-Chip System Fabric (IOSF)). The DMA circuit 122 interfaces with the MAC circuit 124 to prepare frames for transmission. The MAC circuit 124 is able to perform: frame delimiting and recognition; addressing of destination stations (both as individual stations and as groups of stations), conveyance of source-station addressing information, provide transparent data transfer of logical link control (LLC) protocol data units (PDUs) or of equivalent information in the Ethernet sublayer, protection against errors, generally by means of generating and checking frame check sequences, and control of access to the physical transmission medium. In the case of Ethernet, the functions required of a MAC circuit 124 is to: receive/transmit normal frames; provide half-duplex retransmission and backoff functions; append/check FCS (frame check sequence); enforce interframe gap; discard malformed frames; prepend(tx)/remove(rx) preamble, SFD (start frame delimiter), and padding; and provide half-duplex compatibility: append(tx)/remove(rx) MAC address.

The packet parser 108, scheduler circuit 110, DMA circuit 122, and MAC circuit 124 may be implemented using an on-NID CPU 111, an application-specific integrated circuit (ASIC), a field-programmable gate array (FPGA), or other type of computing unit on the NID 102. Further, portions of the packet parser 108, scheduler circuit 110, DMA circuit 122, and MAC circuit 124 may be incorporated into common circuitry, on a same die, or virtualized. It is understood that various arrangements of these components may be used according to available power, area, design, or other factors.

The operating environment 100 also includes central processing unit (CPU) cores 150A, 150B, 150C, and 150N (collectively referred to as 150A-N). Although four cores are illustrated in FIG. 1, it is understood that more or fewer cores may exist in particular CPU architectures. Additionally, there may be multiple CPUs logically grouped together to create a CPU complex. Mechanisms described herein may be used for a single-core CPU, a multi-core CPU, or multiple CPUs acting in concert.

The NID 102 may communicate with the cores 150A-N, main memory 114, or other portions of operating environment 100 via a suitable interconnect channel, such as Peripheral Component Interconnect Express (PCIe) connector 116. PCIe connector 116 may be of any width (e.g., x1, x4, x12, x16, or x32). Other interconnect channels include Intel® On-Chip System Fabric (IOSF), QuickPath Interconnect (QPI), and Primary Scalable Fabric (PSF).

The NID 102 may communicate with cores 150A-N over a bus, such as a PCIe bus. A PCIe client 115 controls the bus and the PCIe connector 116 in the NID 102 that interfaces with a bus controller 118. The PCIe client 115 may perform additional functions, such as controlling allocation of internal resources to virtual domains, support various forms of I/O virtualization (e.g., single root input/output virtualization (SR-IOV)), and other functions. The PCIe bus controller 118 may be incorporated into the same die that includes the cores 150A-N. A platform controller hub may include the PCIe bus controller 118, memory management unit (MMU) 120, Serial ATA controllers, Universal Serial Bus (USB) controllers, clock controller, trusted platform module (TPM), serial-peripheral interface (SPI), and other components in the processor die.

Modern processor architectures have multiple levels in the cache hierarchy before going to main memory. In many designs the outermost level of cache is shared by all cores on the same physical chip (e.g., in the same package) while the innermost cache levels are per core.

In the example illustrated in FIG. 1, each CPU core 150A-N includes a corresponding L1 cache, separated into an L1 instruction cache 152A, 152B, 152C, 152N (collectively referred to as 152A-N) and an L1 data cache 154A, 154B, 154C, 154N (collectively referred to as 154A-N). The cores 150A-N also each include an L2 cache 156A, 156B, 156C, 156N (collectively referred to as 156A-N). The size of the L1 caches and L2 caches vary depending on the processor design. Conventional sizes range from 32 KB to 64 KB for L1 cache size (e.g., 16 KB instruction and 16 KB data, or 32 KB instruction and 32 KB data), and 256 KB to 512 KB for L2 cache size. The cores 150 share an L3 cache 160. L3 cache size may vary from 8 MB to 12 MB or more.

Packet DMA circuitry 170 is used to manage descriptor rings 180, which may be stored in main memory 114, cache memory (e.g., L3 cache 160), or other cache-coherent remote memory (e.g., Compute Express Link™ (CXL™)). Packet DMA circuitry 170 may provide on-the-fly real-time conversions in order to support multiple descriptor formats and descriptor ring specifications. Packet DMA circuitry 170 may also be used to perform generic data movement between threads or virtual machines, for instance, which use descriptor rings. Additional details are set out below.

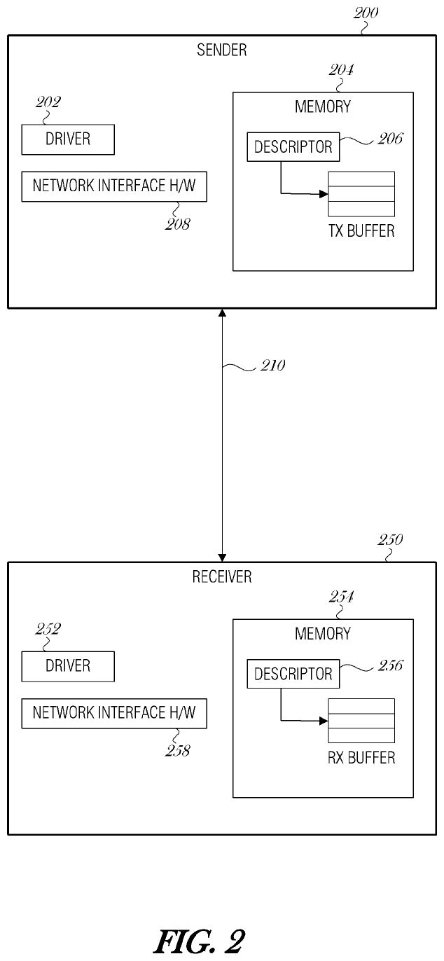

FIG. 2 is a schematic diagram illustrating how a packet is transmitted and received, according to an embodiment. In general, when a sender 200 is ready to transmit data to a receiver 250, the sender 200 uses a network device driver 202 to store data into local memory 204 and create a transmit descriptor 206. The network device driver 202 notifies a network interface hardware 208 (e.g., a network interface card (NIC)) that data is ready to send. The network interface hardware 208 reads the transmit descriptor 206, parses it, and obtains a data from an address in the transmit descriptor. Based on information in the transmit descriptor 206 or the data in the buffer, the network interface hardware 208 packetizes and schedules the data for transmission over a network link 210.

The receiver 250 uses network interface hardware 258 to receive the packetized data, parse the packet, store the packet's contents in local memory 254, and use a receive descriptor 256. The receive descriptor 256 may be allocated by the network device driver 202 for use by the network interface hardware 258 when receiving packets. Upon receipt, the network interface hardware 258 may update fields in the descriptors to indicate a packet is received and other information, such as a length, packet type, etc. The network interface hardware 258 notifies the network device driver 252 that data is available. The notification may be an interrupt or a write to a certain queue (e.g., a used queue or a complete queue), to notify the driver 252 that packets have been received. The network device driver 252 uses the receive descriptor 256 to find the address in local memory 254 where the data is stored. The network device driver 252 then reads the data and processes the packet. This may include actions such as buffering the data in another receive buffer for applications to consume.

In some examples, main memory 114 and local memory 254 may be extended using cache-coherent memory technologies, such as Compute Express Link™ (CXL™). CXL™ is a cache-coherent interconnect for processors, memory expansion, and accelerators. It provides high-speed CPU-to-device and CPU-to-memory connections. In an example, remote or pooled memory may be accessible directly at the hardware level over a Compute Express Link (CXL) standard and may be shared and disaggregated dynamically across the hosts to which it is connected. The pooled memory may also incorporate memory devices (e.g., main memory 114 and local memory 254) and feed into a host adapter. Here, neighboring machines may use pooled memory as a directly attached, active component in the network fabric to substantially boost both data redundancy and resiliency to link failures.

In the example shown in FIG. 2 it is understood that the transmit descriptor 206 and the receive descriptor 256 may be different formats. This is due to the underlying hardware, device drivers, and other configuration settings.

The operations of the sender 200 and receiver 250 may be in the context of a virtual machine (VM) to a physical network device. For instance, the VM may want to send data off of the host device. To do so, the VM packetizes data and transmits it to the host's network interface device, to eventually be repacketized for transfer off of the host device over a wide area network (WAN), local area network (LAN), or other networked environment.

In such an example, the VM's virtual network interface device may use one type of descriptor data structures (e.g., Virtio v0.95) and the host device may use another type of descriptor data structures (e.g., Intel® Ethernet Adaptive Virtual Function (AVF)). To move the data from the VM to the host for transfer off of the host, the data is packetized and transmitted. This uses CPU cycles to emulate the network transmission.

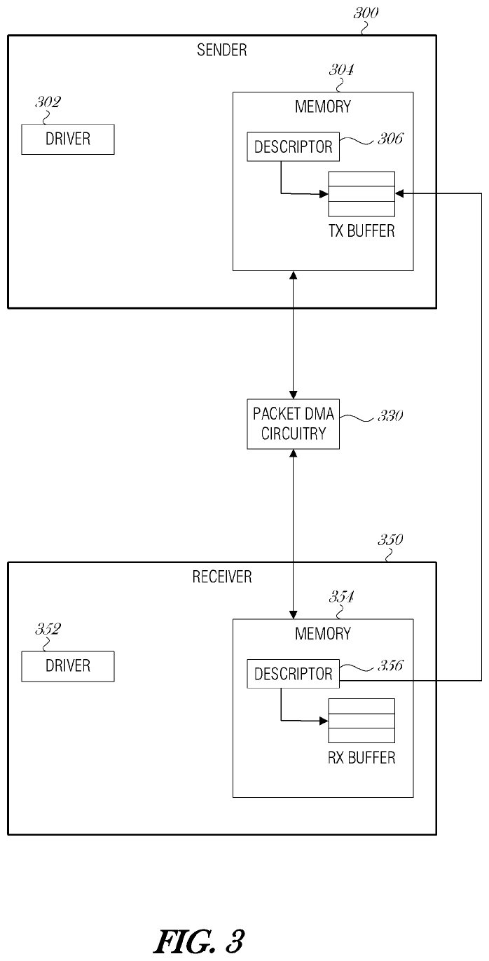

In contrast to this type of operation, FIG. 3 is a schematic diagram illustrating how a packet is transmitted and received using direct memory access (DMA), according to an embodiment. Similar to the arrangement illustrated in FIG. 2, a sender 300 transmits data to a receiver 350. The sender 300 interfaces with a network device driver 302 to store data into local memory 304 and create a transmit descriptor 306.

However, in contrast to the operations discussed in FIG. 2, after the data is stored in the transmit buffer and the transmit descriptor 306 is created, a packet DMA circuitry 330 is used to convert the packet's transmit descriptor 306 to a receive descriptor 356. The packet DMA circuitry 330 may optionally copy or move data from the local memory 304 to local memory 354 of the receiver 350. Once the receive descriptor 356 is created and the data is in the appropriate place as indicated in the receive descriptor 356, the network device driver 352 of the receiver 350 is notified that data is available. The receiver 350 may then operate as if the packet were transferred across a network and received by a network interface hardware of the receiver 350. Thus, the packet DMA circuitry 330 removes the need to emulate packet transmission and receipt.

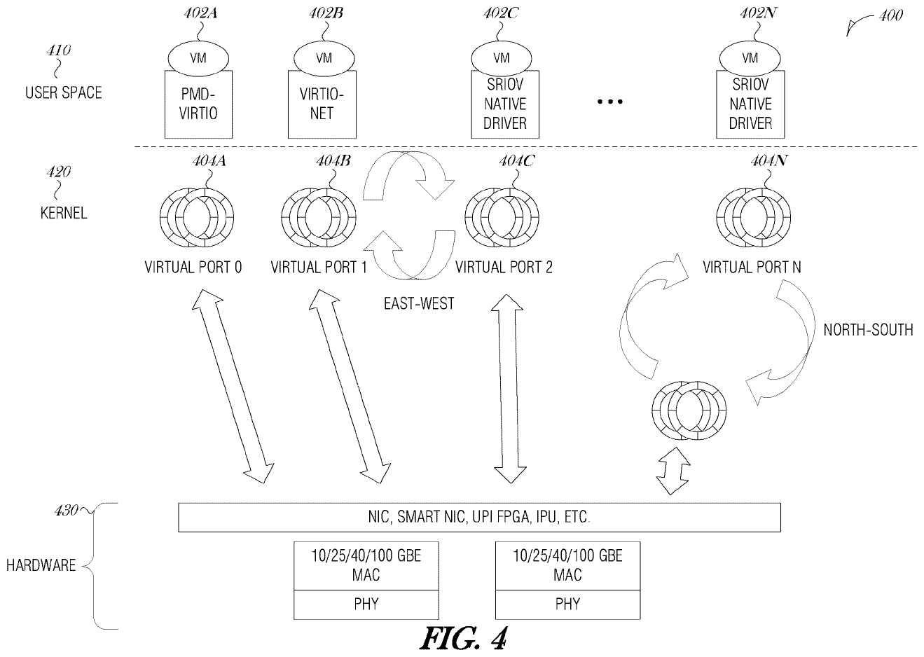

FIG. 4 is a schematic diagram illustrating an operating environment 400, according to an embodiment. The environment includes multiple virtual machines (VMs) 402A, 402B, 402C, . . . , 402N (collectively referred to as 402) operating in user space 410. Each VM 402 implements a virtual network interface device, which has a corresponding descriptor data structure. For instance, VM 402A may support pmd-virtio, VM 402B may support virtio-net, VM 402C may support an SRIOV native driver, and VM 402N may support a different version of an SRIOV native driver. The transmit and receive descriptors 404A, 404B, 404C, . . . , 404N for the corresponding VM 402 are stored in kernel space 420.

The hardware layer 430 may include a network interface card (NIC), Smart NIC, infrastructure processing units (IPU), or programmable hardware (e.g., an FPGA on an Ultra Path Interconnect (UPI)). Descriptors, buffers, and other data for the devices in the hardware layer 430 are managed by device drivers and are typically stored in the kernel space 420. One or more physical network interface devices may exist in the hardware layer 430, with each physical network device having a corresponding descriptor data structure to support packet transmission and receipt.

North-south traffic is traffic that is transmitted and received between a physical interface and a VM's virtual network device. East-west traffic is traffic that is transmitted and received between VMs (VM-to-VM traffic).

From a cloud operation viewpoint, for east-west traffic a cloud operator would prefer to use the same format of virtual interface used by north-south traffic, or even aggregated in a single virtual interface. With VF-passthru, the traffic needs to go thru CPU LLC/memory then into a network interface chip, and then go back to CPU LLC/memory. The interconnect bandwidth (like PCIe) will limit the performance and increase latency. Another methodology is using CPU core to move the packets between VMs, but it also consume CPU cores and packets are copied, which increases memory management overhead. The use of shared memory may avoid the memory copy functions, but there are security implications when using shared memory in a virtualized environment.

Other types of networked endpoints may be used. For instance, Intel® supports a new capability in its Xeon server CPUs called DSA (Data Stream Accelerator. The goal of DSA is to provide higher overall system performance for data mover and transformation operations, while freeing up CPU cycles for higher level functions. Intel® DSA enables high performance data mover capability to/from volatile memory, persistent memory, memory-mapped I/O, and through a Non-Transparent Bridge (NTB) device to/from remote volatile and persistent memory on another node in a cluster. Enumeration and configuration is done with a PCI Express compatible programming interface to the Operating System (OS) and can be controlled through a device driver. Besides the basic data mover operations, Intel® DSA supports a set of transformation operations on memory. For example, Intel® DSA may be used to generate and test CRC checksum, or a Data Integrity Field (DIF) to support storage and networking applications. Additionally, Intel® DSA may be used to implement Memory Compare and delta generate/merge to support VM migration, VM Fast check-pointing, and software-managed memory deduplication usages.

The DSA engines define a new generic descriptor format. To enable the DSA functionality on a system, new driver code is required. Such code may be easily deployable in a new system and newly developed architecture. However, in some scenarios, especially when backward compatibility is required, e.g., running a legacy OS in a VM or bare metal system, the addition of new driver code will add complexity in operation and maintenance.

As such, the packet DMA circuitry discussed in FIG. 3, above, may be used to transfer descriptors and optionally data between network endpoints. These endpoints may include various virtual network interface devices, physical network interface devices, or threads or processes that use a packet receive mechanism based on descriptor data structures. In such implementations, packet descriptors may be referred to as message descriptors. The packet DMA circuitry may be implemented in a way to offload tasks from a CPU, resulting in lower CPU load, lower power usage, and lower data transmission latency. For instance, the use of a specialized circuitry in place of emulated network traffic provides faster data transfer and lower latency.

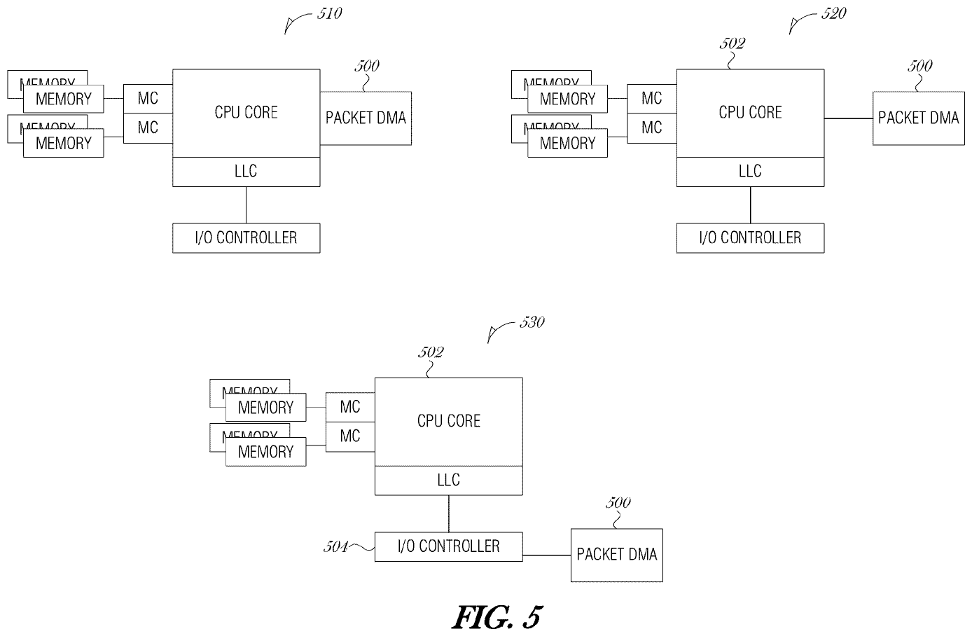

FIG. 5 is a block diagram illustrating various embodiments of a packet DMA circuitry, according to embodiments. Packet DMA circuitry 500 may be arranged, connected, placed, configured, or connected with the system uncore bus (configuration 510). The configuration 510 provides the most bandwidth to access memory and last level cache (LLC). The packet DMA circuitry 500 may be included in the cache coherence domain.

The packet DMA circuitry 500 may alternatively be arranged, connected, placed, configured, or connected via a system bus (e.g., quick path interconnect (QPI) or ultra path interconnect (UPI)) to the CPU core 502 (configuration 520). In this configuration 520, the packet DMA circuitry 500 may be connected with multiple links to have aggregated LLC/memory bandwidth. Further, the packet DMA circuitry 500 may be connected with an input/output (I/O) controller 504, in this configuration 520.

In the last configuration 530 illustrated here, the packet DMA circuitry 500 is connected directly to the I/O controller 504. Access to LLC or memory is handed through the I/O controller 504.

As discussed above, memory devices may include use of CXL or other cache-coherent memory pooling techniques. As such, packet DMA circuitry 500 may interface with CXL-capable memory devices. This may be implemented with a CXL switch to support fan-out to connected devices.

The packet DMA circuitry 500 may be implemented using one or more IPUs. Different examples of IPUs disclosed herein enable improved performance, management, security and coordination functions between entities (e.g., cloud service providers (CSPs)), and enable infrastructure offload and/or communications coordination functions. In particular, one or more IPUs may be used to implement the packet DMA circuitry 500.

IPUs may be integrated with smart NICs and storage or memory (e.g., on a same die, system on chip (SoC), or connected dies) that are located at desktop computers, on-premises systems, base stations, gateways, neighborhood central offices, and so forth. Different examples of one or more IPUs disclosed herein can perform an application composed of microservices, where each microservice runs in its own process and communicates using protocols (e.g., an HTTP resource API, message service or gRPC). Microservices can be independently deployed using centralized management of these services. A management system may be written in different programming languages and use different data storage technologies.

Furthermore, one or more IPUs can execute platform management, networking stack processing operations, security (crypto) operations, storage software, identity and key management, telemetry, logging, monitoring and service mesh (e.g., control how different microservices communicate with one another). The IPU can access an xPU to offload performance of various tasks. For instance, an IPU exposes xPU, storage, memory, and CPU resources and capabilities as a service that can be accessed by other microservices for function composition. This can improve performance and reduce data movement and latency. In general, an IPU can perform capabilities such as those of a router, load balancer, firewall, TCP/reliable transport, a service mesh (e.g., proxy or API gateway), security, data-transformation, authentication, quality of service (QOS), security, telemetry measurement, event logging, initiating and managing data flows, data placement, or job scheduling of resources on an xPU, storage, memory, or CPU.

In some examples, an IPU includes a field programmable gate array (FPGA) structured to receive commands from an CPU, xPU, or application via an API and perform commands/tasks on behalf of the CPU, including workload management and offload or accelerator operations. An IPU may include any number of FPGAs configured and/or otherwise structured to perform any operations of any IPU described herein.

An IPU may interface using compute fabric circuitry, which provides connectivity to a local host or device (e.g., server or device (e.g., xPU, memory, or storage device)). Connectivity with a local host or device or smartNIC or another IPU is, in some examples, provided using one or more of peripheral component interconnect express (PCIe), ARM AXI, Intel® QuickPath Interconnect (QPI), Intel® Ultra Path Interconnect (UPI), Intel® On-Chip System Fabric (IOSF), Omnipath, Ethernet, Compute Express Link (CXL), HyperTransport, NVLink, Advanced Microcontroller Bus Architecture (AMBA) interconnect, OpenCAPI, Gen-Z, CCIX, Infinity Fabric (IF), and so forth. Different examples of the host connectivity provide symmetric memory and caching to enable equal peering between CPU, xPU, and IPU (e.g., via CXL. cache and CXL. mem).

An IPU may include media interfacing circuitry to provide connectivity to a remote smartNIC or another IPU or service via a network medium or fabric. This can be provided over any type of network media (e.g., wired or wireless) and using any protocol (e.g., Ethernet, InfiniBand, Fiber channel, ATM, to name a few).

In some examples, instead of the server/CPU being the primary component managing an IPU, an IPU is a root of a system (e.g., rack of servers or data center) and manages compute resources (e.g., CPU, xPU, storage, memory, other IPUs, and so forth) in the IPU and outside of the IPU. Different operations of an IPU are described below.

In some examples, an IPU performs orchestration to decide which hardware or software is to execute a workload based on available resources (e.g., services and devices) and considers service level agreements and latencies, to determine whether resources (e.g., CPU, xPU, storage, memory) are to be allocated from the local host or from a remote host or pooled resource. In examples when an IPU is selected to perform a workload, secure resource managing circuitry offloads work to a CPU, xPU, or other device and the IPU accelerates connectivity of distributed runtimes, reduce latency, CPU and increases reliability.

In some examples, infrastructure services include a composite node created by an IPU at or after a workload from an application is received. In some cases, the composite node includes access to hardware devices, software using APIs, RPCs, gRPCs, or communications protocols with instructions such as, but not limited, to iSCSI, NVMe-OF, or CXL.

In some cases, an IPU dynamically selects itself to run a given workload (e.g., microservice) within a composable infrastructure including an IPU, xPU, CPU, storage, memory and other devices in a node.

In some examples, communications transit through media interfacing circuitry of an IPU through a NIC/smartNIC (for cross node communications) or loopback back to a local service on the same host. Communications through the example media interfacing circuitry of the IPU to another IPU can then use shared memory support transport between xPUs switched through the local IPUs. Use of IPU-to-IPU communication can reduce latency and jitter through ingress scheduling of messages and work processing based on service level objective (SLO).

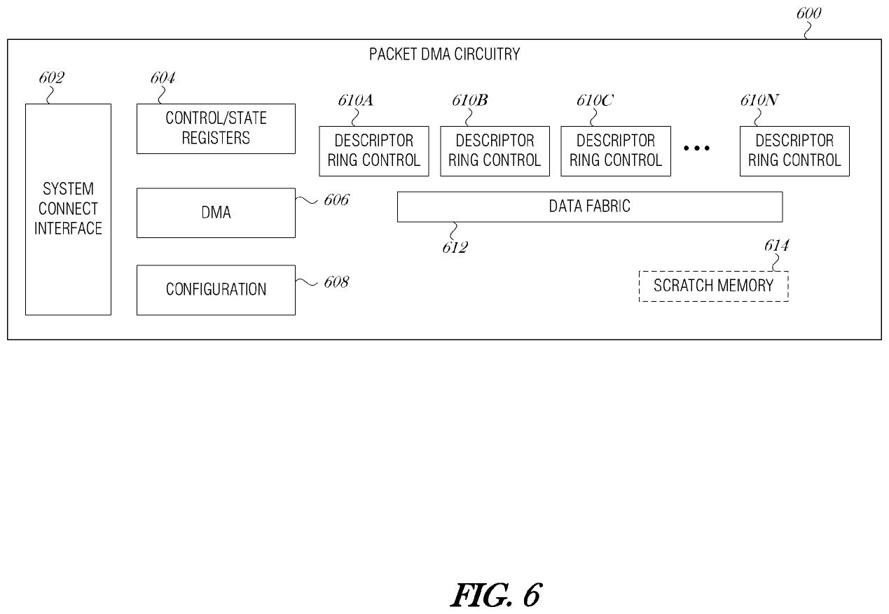

FIG. 6 is a block diagram illustrating components of a packet DMA circuitry 600, according to an embodiment. The packet DMA circuitry 600 includes a system connection interface 602, control/status registers (CSR) 604, direct memory access (DMA) engine 606, configuration management engine 608, descriptor ring control engines 610A, 610B, 610C, . . . , 610N (collectively referred to as 610), and a data fabric 612. The packet DMA circuitry 600 may include optional local scratch memory 614.

The system connection interface 602 is used to communicate with the system uncore, system bus, or I/O bus, such as described in various configurations of FIG. 5. The system connection interface 602 is used to manage underlying link and protocol layer processing.

The control/status registers 604 are used to build a compatible interface from driver/OS viewpoint. For example, if a Virtio 1.0 on PCIe interface is desired, the control/status registers 604 handle all the PCIe CFG cycles for PCIe configuration register access and PCIe Virtio 1.0 PCIe BAR registers MMIO access transactions.

The DMA engine 606 is used to move data to or from one location in system last level cache or memory (e.g., main memory or a CXL-capable device) to another location in cache or memory (e.g., main memory or a CXL-capable device). The descriptor ring control engines 610 are used to parse descriptor ring formats, apply format conversion, and move packet data. Each descriptor ring control engine 610 is capable of supporting one or more network interface devices. The data fabric 612 is a configurable fabric to link descriptor ring control engines 610 and provide them a path to exchange information or data. The configuration management engine 608 is used to manage the configurable part of the descriptor ring control engines 610. The configuration management engine 608 is also used to set up and manage the data fabric 612 and the control/status registers 604. Local scratch memory 614 is used to store information or packet content to support local processing.

During an initial configuration, for example while powering up, the configuration management engine 608 configures one or more descriptor ring control engines 610. A descriptor ring control engine 610 is assigned to handle a particular descriptor and descriptor ring format. For instance, the descriptor ring control engine 610 for Virtio may be configured to read and write a descriptor format, descriptor ring data structure, and associated descriptor ring data structures (e.g., available descriptor ring and used descriptor ring for Virtio). Other descriptors and descriptor ring formats include, but are not limited to, Virtio, Intel® Ethernet Adaptive Virtual Function (AVF), Data Plane Development Kit (DPDK) mbuf, and the like.

The descriptor ring control engine 610 may be configured with some or all of the following types of information: transmit descriptor format, memory address of transmit descriptor ring, receive descriptor format, memory address of receive descriptor ring, identifier of descriptor format, head of available descriptor ring, head of used descriptor ring, control register addresses for descriptor rings, control register addresses for a corresponding network interface device, interrupt signaling information, and the like.

Configuration may include loading corresponding configuration data from the host system. The configuration can include but not limit to the parameters, codes/executables, bitstreams, or device CSR register definition. The configuration data can be generated in advance and pre-stored in system storage or the configuration data can be generated at runtime according to some level of description and compiled into a loadable bitstream, code, or executable.

After configuring the descriptor ring control engines 610, the context of the corresponding descriptor ring is loaded into the corresponding descriptor ring control engine 610. This may include loading the physical memory address of descriptor rings, head and tail information or other state information of the descriptor rings, a memory address translation table (e.g., a guest physical address to host physical address), a snapshot of control values for control/status registers (e.g., for live migration), or the like.

Once the descriptor ring control engines 610 is fully configured, they may perform format conversion from a source descriptor ring format to a target descriptor ring format. Depending on the where the data is stored and in what format it is stored, the descriptor ring control engines 610 may move data from a source address to a target address and reformat the data to conform to the target descriptor ring format.

After providing the descriptor ring reformatting and optional data movement, the descriptor ring control engines 610 perform cleanup operations at the source descriptor ring and the target descriptor ring. Cleanup operations may include activities such as writing to an available ring and a used ring for Virtio, performing a writeback operation in Intel® AVF, or initiating a notification or interrupt to hardware or a device driver, for example.

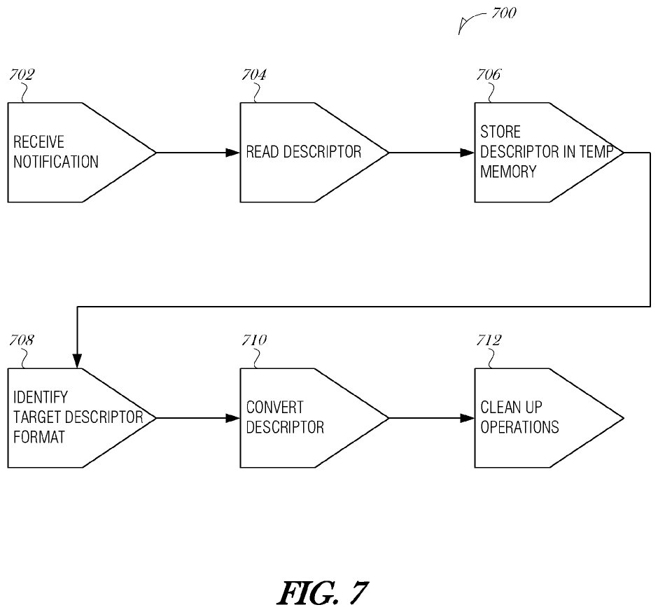

FIG. 7 is a block diagram illustrating data and control flow 700 for descriptor format conversion, according to an embodiment. At 702, a notification is received by a descriptor ring control engine (e.g., descriptor ring control engine 610 of FIG. 6) indicating that a new packet is ready to transmit. The descriptor ring control engine is configured to read a packet descriptor and corresponding packet descriptor data structures. The notification indicates that a packet descriptor was stored in a packet descriptor ring, so at 704, the descriptor ring control engine reads the descriptor from the descriptor ring. The descriptor information may be stored in a local memory for the descriptor ring control engine (operation 706).

In some embodiments, the descriptor ring control engine may be configured, adapted, programmed, or designed to convert a descriptor from a source format to an intermediate format. Thus, there may be a single descriptor ring control engine for each supported type of descriptor (e.g., one for Virtio, one for Intel® AVF, one for Microsoft® Hyper-V, etc.). Each descriptor ring control engine is then able to convert from a source descriptor that they are aligned with to an intermediate format. Each descriptor format is also configured, adapted, programmed, or designed to convert from an intermediate format to the supported type of descriptor. As such, to convert from format A to format B, a descriptor ring control engine for format A may convert a descriptor in format A to an intermediate format, and then a descriptor ring control engine for format B may be used to convert the descriptor from the intermediate format to a descriptor in format B.

Alternatively, in other embodiments, the descriptor ring control engine may be configured, adapted, programmed, or designed to convert a descriptor from a source format to a target format directly. The descriptor ring control engine may be able to read from a single source format and write to multiple different output target formats. While such an arrangement may increase the complexity of a descriptor ring control engine, it has an advantage of reducing data and control flow between descriptor ring control engines. It may also remove race conditions or other issues that could arise from packet descriptor processing timing.

At 708, a target descriptor format is identified. The descriptor ring control engine or another descriptor ring control engine is used to transform the source descriptor to an output descriptor using the target descriptor format. The output descriptor is then written to a receive descriptor ring for the target network interface (operation 710). At 712, cleanup operations are performed, such as by updating the source descriptor data structures to indicate that the source descriptor was successfully dequeued, writing back to the source descriptor ring, or providing notifications to device drivers or hardware. The descriptor ring control engine that consumed the source descriptor may be used to perform operation 712. Alternatively, if two or more descriptor ring control engines are working together, the descriptor ring control engine that processes the output descriptor may perform the cleanup activities. It is also understood that two or more descriptor ring control engines may act together to perform these activities.

The descriptor ring control engines may be implemented as a micro engine for descriptor ring control with the micro engine instruction optimized for descriptor ring handling. The processing procedure of descriptor ring handing may be described with a high-level language or programming language and compiled into micro engine executable. The descriptor ring control engines may be implemented as a Fine-Grained Reconfigurable Array (FGRA) or Coarse-Graining Reconfigurable Array (CGRA) for descriptor ring control. The processing procedure of descriptor ring can be described as some high-level language or hardware description language (HDL) and compiled into FGRA/CFGA configuration data. It is also understood that the descriptor ring control engines may be implemented as mixture of fixed function and configurable portions.

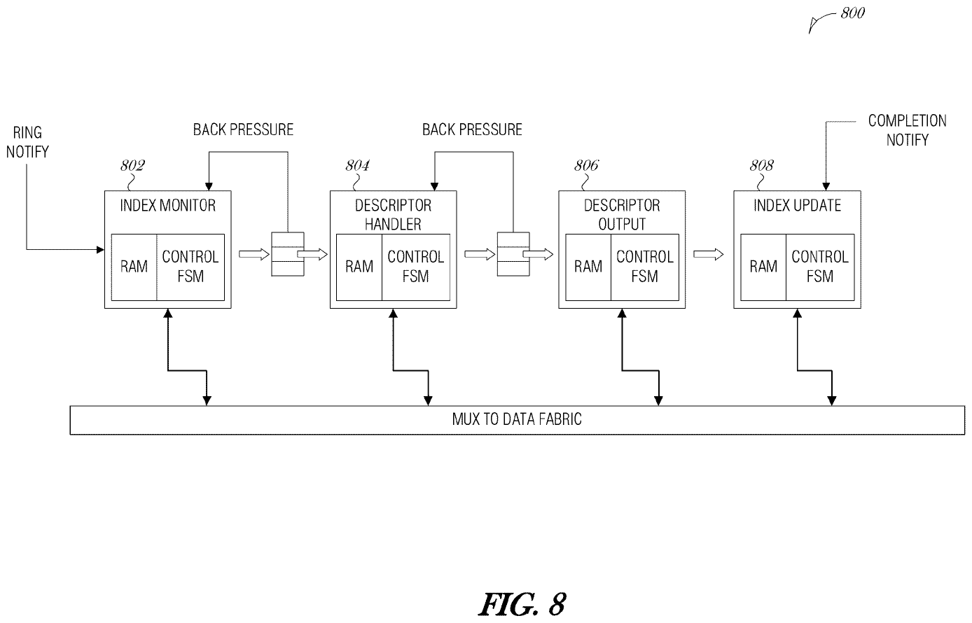

FIG. 8 is a block diagram illustrating a descriptor ring control engine 800, according to an embodiment. A descriptor ring control engine 800 may be composed of several sub-blocks and implement a hardware pipeline among them. Each sub-block function may include fixed circuitry to facility accessing and manipulating local data structures stored in memory (e.g., random access memory, DIMM, CXL-capable devices, etc.) and hardware first-in-first-out (FIFO) queues, which may be stored in registers. A finite state machine (FSM) or other control mechanism may be used to provide operation to fulfil various operations, such as checking or modifying data structures in memory, control operation, etc. The sub-blocks maybe connected to a data fabric multiplexer (MUX) for direct memory access (DMA) via circuitry (e.g., packet DMA circuitry 330).

The descriptor ring control engine 800 illustrated in FIG. 8 is configured to handle a source descriptor in a first format (e.g., in a Virtio descriptor format) and output a descriptor in a second format (e.g., an Intel® AVF descriptor format). It is understood that this example is non-limiting and that other types of implementations may be used consistent with the present disclosure.

The descriptor ring control engine 800 includes an index monitor sub-block 802, a descriptor handler sub-block 804, a descriptor output sub-block 806, and an index update sub-block 808. It is understood that more or fewer sub-blocks may be used. Sub-blocks may be implemented as fixed hardware, programmable hardware (e.g., FPGA, FGRA, CGCRA, etc.), or combinations thereof.

Virtio is a family of virtual devices for virtual environments. To a guest within the virtual environment, a Virtio device looks like a physical device. In general, Virtio devices use normal bus mechanisms of interrupts and DMA. These devices consist of rings of descriptors for both input (i.e., receive) and output (i.e., transmit), which are laid out to avoid cache conflicts where both a driver and a device may attempt to write to the same cache lines. Virtio uses a mechanism for bulk data transport called a virtqueue, which includes a descriptor table, an available ring, and a used ring. The descriptor table is similar to a descriptor ring found in other protocols. The descriptor table is used to refer to buffers the driver is using for the device. The descriptor table includes an addr field (i.e., the guest physical address of the corresponding buffer data), a len field (i.e., the length in bytes of the buffer data), a next field (i.e., the next descriptor in the table), and a flags field (i.e., control flags for the descriptor). A descriptor may be device-readable or device-writable, where device-readable descriptors are used for output (i.e., transmit) descriptors that were put in the descriptor table by the driver, and device-writable descriptors are used for input (i.e., receive) descriptors that were put in the descriptor table by the device.

The available ring is used to indicate the which descriptor table entries are available. The used ring is where the device releases buffers once the device is done with them. The used ring is only written to by the device and read by the driver. An index is used to indicate to the driver where the next descriptor entry should go in the used ring.

The index monitor sub-block 802 monitors for a notification message, such as Ring Notify, which indicates that one or more descriptors are ready for processing. Ring Notify can be either triggered by a MMIO doorbell to CSR or from a polling result. For instance, index monitor sub-block 802 may poll and read the index value from time to time. In response to the notification or polling, the index monitor sub-block 802 reads the latest available index and an available ring structure to get the real descriptor index. Because the index monitor sub-block 802 may be monitoring several Virtio virtqueues, each virtqueue is associated with a queue identifier. This queue ID may be assigned by the index monitor sub-block 802 or the another part of the descriptor ring control engine 800. The index monitor sub-block 802 identifies the queue ID of the virtqueue that is being processed. The index monitor sub-block 802 passes the queue ID and descriptor index to the descriptor handler sub-block 804. This information may be transmitted using FIFOs that are placed between the sub-blocks and are used as temporary storage. The FIFOs allow each sub-block to run concurrently and achieve hardware pipelining for better performance. The FIFOs may be limited in size and a backpressure signal may be used to prevent the FIFO from overflowing. Descriptors that are rejected because of FIFO overflow may be retried a number of times before being aborted.

The descriptor handler sub-block 804 uses the queue ID and descriptor index as input, then read the contents of descriptor from the descriptor table. Depending on whether the descriptor entry is an indirect descriptor or a direct descriptor, the descriptor handler sub-block 804 may have to resolve a linked list of descriptors to obtain the full descriptor information. The descriptor handler sub-block 804 is then used to perform descriptor conversion to desired descriptor format. For instance, the source descriptor format may be Virtio and the target descriptor format may be AVF.

The descriptor handler sub-block 804 then resolves the target queue ID. Again, because there may be more than one device being handled that use the same descriptor format, the receive descriptor ring is identified internally by a target queue ID. The target queue ID refers to the receive descriptor ring of the target device.

Network devices managed by packet DMA circuitry 600 or descriptor ring control engine 800 may be identified at system start up, for example. The devices may report configuration data to record the various network devices in a lookup table or other reference area. The lookup table may include the addresses of transmit and receive descriptor rings, descriptor format, network device address, port number, and the like. Based on information from the descriptor or the data blocks referred to by the descriptor, the descriptor handler sub-block 804 may identify the target network device and then obtain the memory address, queue ID, or other indication of the target receive descriptor ring. Device configuration information may be provided to the descriptor handler sub-block 804 by a configuration management engine (e.g., configuration management engine 608).

The descriptor handler sub-block 804 outputs the target queue ID, descriptor index of the source descriptor table, and the converted descriptor content to the descriptor output sub-block 806.

The descriptor output sub-block 806 writes the converted descriptor content to the memory mapped position for a particular queue. This memory mapped position may be identified by the descriptor output sub-block 806 or descriptor handler sub-block 804, such as by referencing a lookup table.

Additionally, descriptor output sub-block 806 may check if there are enough descriptor entries available in the target descriptor ring before writing. After a successful write, the descriptor output sub-block 806 passes information to the index update sub-block 808.

The index update sub-block 808 is used to perform additional postprocessing after a descriptor is consumed. For example, in Virtio, after a descriptor was used, a write to the used ring is required. For AVF, when a packet is received, a writeback with packet length is required toward either the address of descriptor or a completion queue depending on configuration. The index update sub-block 808 generates corresponding updates to the source descriptor ring and appropriate notification of events, such as interrupts, to the target network device.

Depending on the configuration or types of descriptor rings, the index update sub-block 808 may also copy the data from the address indicated in the source descriptor ring to a memory location accessible by the target descriptor ring. For instance, due to memory mapping limitations, security limitations, or the like, an address in a source descriptor ring may not be accessible by the network device from the target descriptor ring. As such, the index update sub-block 808 may copy the buffer contents to the target buffer and revise the address stored in the target descriptor ring.

By using the descriptor format conversion and copying, the host processor is removed from network processing. The mechanisms described here allow for north-south or east-west message passing by directly accessing descriptors, descriptor rings, and buffer contents.

For example, in a given system, one or more network interface cards may be attached and running with their proprietary ring buffer layout, for example Intel® AVF. Also, a kernel based virtual machine (KVM) may be used to support multiple VMs running on the system, each using a virtual network port to provide network communication. This may be provided by way of Virtio. Some of descriptor ring control engines inside a reconfigurable packet DMA engine can be configured to interpret physical NIC descriptors and other descriptor ring control engines can be configured to interpret Virtio descriptor ring descriptors and data structures used by virtual ports. Once the mapping is setup properly, the packets come from physical network interface can be fed into VMs without CPU core intervention. Note that, also within the same hardware platform the reconfigurable packet DMA engine can support other VMMs, such as Microsoft® Hyper-V or Azure® VNet.

In summary, the mechanisms described herein assist current networked system to overcome the overhead and complexity of descriptor ring conversion. These mechanisms also have the flexibility to adapt to different descriptor ring formats and be reconfigured on the fly. It is also beneficial in virtualized environments to decouple the underlying network interface implementation to guest VM and provide an efficient way for VM to VM, or thread to thread, traffic.

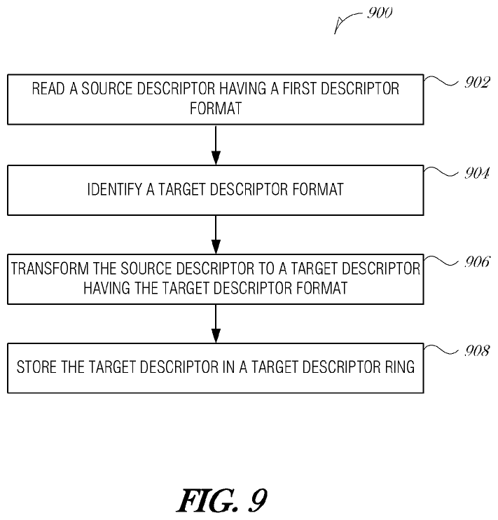

FIG. 9 is a flowchart illustrating a method 900 for packet descriptor handling performed at a hardware device, according to an embodiment. At 902, a source descriptor from a source descriptor ring is read from a memory device, using direct memory access (DMA). The source descriptor refers to a packet data and the source descriptor has a first descriptor format.

In an embodiment, reading the source descriptor includes receiving a notification of a descriptor to process, identifying the source descriptor ring associated with the descriptor to process, and reading, using DMA, the source descriptor from the source descriptor ring.

At 904, a target descriptor format is identified. In an embodiment, identifying the target descriptor format includes parsing the source descriptor to obtain a memory address; reading, using DMA, the packet data from the memory address; parsing the packet data to obtain a target network device; and identifying the target descriptor format based on the target network device.

At 906, the source descriptor is transformed to a target descriptor. The target descriptor refers to the packet data and has the target descriptor format. In an embodiment, transforming the source descriptor to the target descriptor includes rearranging contents of the source descriptor to have an arrangement compatible with the target descriptor format.

At 908, the target descriptor is stored in a target descriptor ring in the memory device, using DMA.

In an embodiment, the method 900 includes parsing the source descriptor to obtain a source memory address in the memory device; reading, using DMA, the packet data from the source memory address; identifying a target memory address; copying, using DMA, the packet data from the source memory address to the target memory address; and storing, using DMA, the target memory address in the target descriptor.

Although the examples described herein are described in the context of a host computer platform with physical and virtual network devices (e.g., a NIC), it is understood that switches, routers, or other network appliances may use the same or similar mechanisms to manage descriptors. For example, to the extent that OSI L2/L3 devices use descriptors, then the descriptor handing implementations may be applied to such platforms.

### Hardware Platform

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instructions on the machine-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of engines, components, modules, or mechanisms. Engines, components, modules, or mechanisms may be hardware, software, or firmware communicatively coupled to one or more processors in order to carry out the operations described herein. Engines, components, modules, or mechanisms may be hardware modules, and as such modules may be considered tangible entities capable of performing specified operations and may be configured or arranged in a certain manner. In an example, circuits may be arranged (e.g., internally or with respect to external entities such as other circuits) in a specified manner as an engine, component, module, or mechanism. In an example, the whole or part of one or more computer systems (e.g., a standalone, client or server computer system) or one or more hardware processors may be configured by firmware or software (e.g., instructions, an application portion, or an application) as a that operates to perform specified operations. In an example, the software may reside on a machine-readable medium. In an example, the software, when executed by the underlying hardware of the engine, component, module, or mechanism, causes the hardware to perform the specified operations. Accordingly, the term “hardware engine,” “hardware component,” “hardware module,” or “hardware mechanism” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which engines, components, modules, or mechanisms are temporarily configured, each of them need not be instantiated at any one moment in time. For example, where the engines comprise a general-purpose hardware processor configured using software; the general-purpose hardware processor may be configured as respective different engines at different times. Software may accordingly configure a hardware processor, for example, to constitute a particular engine at one instance of time and to constitute a different engine at a different instance of time. Engines, components, modules, or mechanisms may also be software or firmware modules, which operate to perform the methodologies described herein.

Engines are tangible entities capable of performing specified operations and may be configured or arranged in a certain manner. Engines may be realized as hardware circuitry, as well one or more processors programmed via software or firmware (which may be stored in a data storage device interfaced with the one or more processors), in order to carry out the operations described herein. In this type of configuration, an engine includes both, the software, and the hardware (e.g., circuitry) components. In an example, circuits may be arranged (e.g., internally or with respect to external entities such as other circuits) in a specified manner as an engine. In an example, the whole or part of one or more computer systems (e.g., a standalone, client or server computer system) or one or more hardware processors may be configured by firmware or software (e.g., instructions, an application portion, or an application) as an engine that operates to perform specified operations. In an example, the software may reside on a machine-readable medium. In an example, the software, when executed by the underlying hardware of the engine, causes the hardware to perform the specified operations. Accordingly, the term hardware engine is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein.

Circuitry or circuits, as used in this document, may comprise, for example, singly or in any combination, hardwired circuitry, programmable circuitry such as computer processors comprising one or more individual instruction processing cores, state machine circuitry, and/or firmware that stores instructions executed by programmable circuitry. The circuits, circuitry, or modules may, collectively or individually, be embodied as circuitry that forms part of a larger system, for example, an integrated circuit (IC), system on-chip (SoC), desktop computers, laptop computers, tablet computers, servers, smart phones, etc.

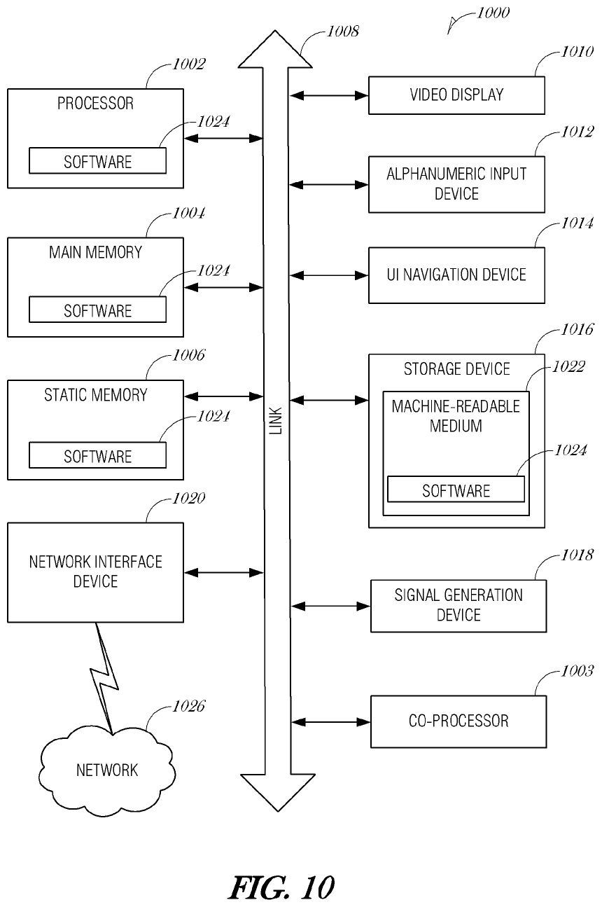

FIG. 10 is a block diagram illustrating a machine in the example form of a computer system 1000, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a mobile device, vehicle infotainment system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 1000 includes at least one processor 1002 (e.g., a central processing unit (CPU), a graphics processing unit (GPU) or both, processor cores, compute nodes, etc.), at least one co-processor 1003 (e.g., FPGA, specialized GPU, ASIC, etc.), a main memory 1004 and a static memory 1006, which communicate with each other via a link 1008 (e.g., bus). Main memory 1004 may be extended using CXL-capable devices or other cache-coherent memory techniques. The link 1008 may be provided using one or more of peripheral component interconnect express (PCIe), ARM AXI, Intel® QuickPath Interconnect (QPI), Intel® Ultra Path Interconnect (UPI), Intel® On-Chip System Fabric (IOSF), Omnipath, Ethernet, Compute Express Link (CXL), HyperTransport, NVLink, Advanced Microcontroller Bus Architecture (AMBA) interconnect, OpenCAPI, Gen-Z, CCIX, Infinity Fabric (IF), and so forth. Different examples of the host connectivity provide symmetric memory and caching to enable equal peering between CPU, xPU, and IPU (e.g., via CXL. cache and CXL. mem).

The computer system 1000 may further include a video display unit 1010, an alphanumeric input device 1012 (e.g., a keyboard), and a user interface (UI) navigation device 1014 (e.g., a mouse). In one embodiment, the video display unit 1010, input device 1012 and UI navigation device 1014 are incorporated into a touch screen display. The computer system 1000 may additionally include a storage device 1016 (e.g., a drive unit), a signal generation device 1018 (e.g., a speaker), a network interface device 1020, and one or more sensors (not shown), such as a global positioning system (GPS) sensor, compass, accelerometer, gyrometer, magnetometer, or other sensor.

The storage device 1016 includes a machine-readable medium 1022 on which is stored one or more sets of data structures and instructions 1024 (e.g., software) embodying or utilized by any one or more of the methodologies or functions described herein. The instructions 1024 may also reside, completely or at least partially, within the main memory 1004, static memory 1006, and/or within the processor 1002 during execution thereof by the computer system 1000, with the main memory 1004, static memory 1006, and the processor 1002 also constituting machine-readable media.

While the machine-readable medium 1022 is illustrated in an example embodiment to be a single medium, the term “machine-readable medium” may include a single medium or multiple media (e.g., a centralized or distributed database, and/or associated caches and servers) that store the one or more instructions 1024. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 1024 may further be transmitted or received over a communications network 1026 using a transmission medium via the network interface device 1020 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Bluetooth, Wi-Fi, 3G, and 4G LTE/LTE-A). The term “transmission medium” shall be taken to include any intangible medium that is capable of storing, encoding, or carrying instructions for execution by the machine, and includes digital or analog communications signals or other intangible medium to facilitate communication of such software.

Network interface device 1020 may be configured or programmed to implement the methodologies described herein. In particular, the network interface device 1020 may provide various aspects of packet inspection, aggregation, queuing, and processing. The network interface device 1020 may also be configured or programmed to communicate with a memory management unit (MMU), processor 1002, main memory 1004, static memory 1006, or other components of the system 1000 over the link 1008. The network interface device 1020 may query or otherwise interface with various components of the system 1000 to inspect cache memory; trigger or cease operations of a virtual machine, process, or other processing element; or otherwise interact with various computing units or processing elements that are in the system 1000 or external from the system 1000.

### Additional Notes & Examples

Example 1 is packet direct memory access (DMA) circuitry for packet descriptor handling, comprising: a system connect interface to a memory device, the memory device used to store packet descriptor rings; a direct memory access (DMA) engine to directly read and write to the memory device over the system connect interface, bypassing a host processor; a first descriptor ring control engine to transform a first packet descriptor that refers to a packet data and that has a first packet descriptor format to a second packet descriptor that refers to the packet data and has a second packet descriptor format, wherein the first and second packet descriptors are stored in the memory device; and a second packet descriptor ring control engine to transform packet descriptors having the second packet descriptor format to packet descriptors with a third packet descriptor format.

In Example 2, the subject matter of Example 1 includes, wherein the memory device is a last level cache of a host processor coupled to the packet DMA circuitry.

In Example 3, the subject matter of Examples 1-2 includes, wherein the memory device is a main memory of a host processor coupled to the packet DMA circuitry.

In Example 4, the subject matter of Examples 1-3 includes, wherein the memory device is a cache-coherent memory device accessible by the packet DMA circuitry.

In Example 5, the subject matter of Examples 1-4 includes, wherein to transform the first packet descriptor to the second packet descriptor, the first descriptor ring control engine is to: read, using the DMA engine, the first packet descriptor from a first packet descriptor ring, the first packet descriptor ring stored in the memory device; identify the second descriptor format; transform the first packet descriptor to the second packet descriptor, the first packet descriptor having the first packet descriptor format and the second packet descriptor having the second packet descriptor format; and store, using the DMA engine, the second packet descriptor in a second packet descriptor ring.

In Example 6, the subject matter of Example 5 includes, wherein to read the first packet descriptor, the first descriptor ring control engine is to: receive a notification of a descriptor to process; identify the first packet descriptor ring associated with the descriptor to process; and read, using the DMA engine, the first packet descriptor from the first packet descriptor ring.

In Example 7, the subject matter of Examples 5-6 includes, wherein to identify the second packet descriptor format, the first descriptor ring control engine is to: parse the first packet descriptor to obtain a memory address; read, using the DMA engine, the packet data from the memory address; parse the packet data to obtain a target network device; and identify the second packet descriptor format based on the target network device.

In Example 8, the subject matter of Examples 5-7 includes, wherein to transform the first packet descriptor to the second packet descriptor the first descriptor ring control engine is to rearrange contents of the first packet descriptor to have an arrangement compatible with the second packet descriptor format.

In Example 9, the subject matter of Examples 5-8 includes, wherein the first descriptor ring control engine is to: parse the first packet descriptor to obtain a source memory address in the memory device; read, using the DMA engine, the packet data from the source memory address; identify a target memory address; copy, using the DMA engine, the packet data from the source memory address to the target memory address; and store, using the DMA engine, the target memory address in the second packet descriptor.

In Example 10, the subject matter of Examples 1-9 includes, wherein the first packet descriptor format is compatible with a first virtual network interface device.

In Example 11, the subject matter of Example 10 includes, wherein the second packet descriptor format is compatible with a second virtual network interface device.

In Example 12, the subject matter of Examples 1-11 includes, wherein the first packet descriptor format is compatible with a physical network interface device.

In Example 13, the subject matter of Example 12 includes, wherein the second packet descriptor format is compatible with a second virtual network interface device.

In Example 14, the subject matter of Examples 1-13 includes, wherein the first packet descriptor format is compatible with a virtual network interface device.

In Example 15, the subject matter of Example 14 includes, wherein the second packet descriptor format is compatible with a physical network interface device.

Example 16 is a method for packet descriptor handling performed at a hardware device, comprising: reading from a memory device, using direct memory access (DMA), a source descriptor from a source descriptor ring, the source descriptor referring to a packet data and the source descriptor having a first descriptor format; identifying a target descriptor format; transforming the source descriptor to a target descriptor, the target descriptor referring to the packet data and having the target descriptor format; and storing in the memory device, using DMA, the target descriptor in a target descriptor ring.

In Example 17, the subject matter of Example 16 includes, wherein reading the source descriptor comprises: receiving a notification of a descriptor to process; identifying the source descriptor ring associated with the descriptor to process; and reading, using DMA, the source descriptor from the source descriptor ring.

In Example 18, the subject matter of Examples 16-17 includes, wherein identifying the target descriptor format comprises: parsing the source descriptor to obtain a memory address; reading, using DMA, the packet data from the memory address; parsing the packet data to obtain a target network device; and identifying the target descriptor format based on the target network device.

In Example 19, the subject matter of Examples 16-18 includes, wherein transforming the source descriptor to the target descriptor comprises rearranging contents of the source descriptor to have an arrangement compatible with the target descriptor format.

In Example 20, the subject matter of Examples 16-19 includes, parsing the source descriptor to obtain a source memory address in the memory device; reading, using DMA, the packet data from the source memory address; identifying a target memory address; copying, using DMA, the packet data from the source memory address to the target memory address; and storing, using DMA, the target memory address in the target descriptor.

Example 21 is at least one machine-readable medium including instructions, which when executed by a machine, cause the machine to perform operations of any of the methods of Examples 16-20.

Example 22 is an apparatus comprising means for performing any of the methods of Examples 16-20.

Example 23 is a compute system comprising: a host processor; a memory device; and packet direct memory access (DMA) circuitry for packet descriptor handling, comprising: a system connect interface to the memory device, the memory device used to store packet descriptor rings; a direct memory access (DMA) engine to directly read and write to the memory device over the system connect interface, bypassing the host processor; a first descriptor ring control engine to transform a first packet descriptor that refers to a packet data and that has a first packet descriptor format to a second packet descriptor that refers to the packet data and has a second packet descriptor format, wherein the first and second packet descriptors are stored in the memory device; and a second packet descriptor ring control engine to transform packet descriptors having the second packet descriptor format to packet descriptors with a third packet descriptor format.

In Example 24, the subject matter of Example 23 includes, wherein the memory device is a last level cache of the host processor.

In Example 25, the subject matter of Examples 23-24 includes, wherein the memory device is a main memory of the host processor.

In Example 26, the subject matter of Examples 23-25 includes, wherein the memory device is a cache-coherent memory device accessible by the packet DMA circuitry.

In Example 27, the subject matter of Examples 23-26 includes, wherein to transform the first packet descriptor to the second packet descriptor, the first descriptor ring control engine is to: read, using the DMA engine, the first packet descriptor from a first packet descriptor ring, the first packet descriptor ring stored in the memory device; identify the second descriptor format; transform the first packet descriptor to the second packet descriptor, the first packet descriptor having the first packet descriptor format and the second packet descriptor having the second packet descriptor format; and store, using the DMA engine, the second packet descriptor in a second packet descriptor ring.

In Example 28, the subject matter of Example 27 includes, wherein to read the first packet descriptor, the first descriptor ring control engine is to: receive a notification of a descriptor to process; identify the first packet descriptor ring associated with the descriptor to process; and read, using the DMA engine, the first packet descriptor from the first packet descriptor ring.

In Example 29, the subject matter of Examples 27-28 includes, wherein to identify the second packet descriptor format, the first descriptor ring control engine is to: parse the first packet descriptor to obtain a memory address; read, using the DMA engine, the packet data from the memory address; parse the packet data to obtain a target network device; and identify the second packet descriptor format based on the target network device.

In Example 30, the subject matter of Examples 27-29 includes, wherein to transform the first packet descriptor to the second packet descriptor the first descriptor ring control engine is to rearrange contents of the first packet descriptor to have an arrangement compatible with the second packet descriptor format.

In Example 31, the subject matter of Examples 27-30 includes, wherein the first descriptor ring control engine is to: parse the first packet descriptor to obtain a source memory address in the memory device; read, using the DMA engine, the packet data from the source memory address; identify a target memory address; copy, using the DMA engine, the packet data from the source memory address to the target memory address; and store, using the DMA engine, the target memory address in the second packet descriptor.

In Example 32, the subject matter of Examples 23-31 includes, wherein the first packet descriptor format is compatible with a first virtual network interface device.

In Example 33, the subject matter of Example 32 includes, wherein the second packet descriptor format is compatible with a second virtual network interface device.

In Example 34, the subject matter of Examples 23-33 includes, wherein the first packet descriptor format is compatible with a physical network interface device.

In Example 35, the subject matter of Example 34 includes, wherein the second packet descriptor format is compatible with a second virtual network interface device.

In Example 36, the subject matter of Examples 23-35 includes, wherein the first packet descriptor format is compatible with a virtual network interface device.

In Example 37, the subject matter of Examples 32-36 includes, wherein the second packet descriptor format is compatible with a physical network interface device.

Example 38 is at least one machine-readable medium including instructions for packet descriptor handling, which when executed by a hardware device, cause the hardware device to perform operations comprising reading from a memory device, using direct memory access (DMA), a source descriptor from a source descriptor ring, the source descriptor referring to a packet data and the source descriptor having a first descriptor format; identifying a target descriptor format; transforming the source descriptor to a target descriptor, the target descriptor referring to the packet data and having the target descriptor format; and storing in the memory device, using DMA, the target descriptor in a target descriptor ring.

In Example 39, the subject matter of Example 38 includes, wherein the instructions for reading the source descriptor comprise instructions for: receiving a notification of a descriptor to process; identifying the source descriptor ring associated with the descriptor to process; and reading, using DMA, the source descriptor from the source descriptor ring.

In Example 40, the subject matter of Examples 38-39 includes, wherein the instructions for identifying the target descriptor format comprise instructions for: parsing the source descriptor to obtain a memory address; reading, using DMA, the packet data from the memory address; parsing the packet data to obtain a target network device; and identifying the target descriptor format based on the target network device.

In Example 41, the subject matter of Examples 38-40 includes, wherein the instructions for transforming the source descriptor to the target descriptor comprise instructions for rearranging contents of the source descriptor to have an arrangement compatible with the target descriptor format.

In Example 42, the subject matter of Examples 38-41 includes, instructions, which when executed by the hardware device, cause the hardware device to perform operations comprising: parsing the source descriptor to obtain a source memory address in the memory device; reading, using DMA, the packet data from the source memory address; identifying a target memory address; copying, using DMA, the packet data from the source memory address to the target memory address; and storing, using DMA, the target memory address in the target descriptor.

Example 43 is at least one machine-readable medium including instructions that, when executed by processing circuitry, cause the processing circuitry to perform operations to implement of any of Examples 1-42.

Example 44 is an apparatus comprising means to implement of any of Examples 1-42.

Example 45 is a system to implement of any of Examples 1-42.

Example 46 is a method to implement of any of Examples 1-42.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described.

However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1-25. (canceled)

26. Packet direct memory access (DMA) circuitry for packet descriptor handling, comprising:
a system connect interface to a memory device, the memory device used to store packet descriptor rings;
direct memory access (DMA) engine to directly read and write to the memory device over the system connect interface, bypassing a host processor;
first descriptor ring control engine to transform a first packet descriptor that refers to a packet data and that has a first packet descriptor format to a second packet descriptor that refers to the packet data and has a second packet descriptor format, wherein the first and second packet descriptors are stored in the memory device; and
second packet descriptor ring control engine to transform packet descriptors having the second packet descriptor format to packet descriptors with a third packet descriptor format.

27. The packet DMA circuitry of claim 26, wherein the memory device is a last level cache of a host processor coupled to the packet DMA circuitry.

28. The packet DMA circuitry of claim 26, wherein the memory device is a main memory of a host processor coupled to the packet DMA circuitry.

29. The packet DMA circuitry of claim 26, wherein the memory device is a cache-coherent memory device accessible by the packet DMA circuitry.

30. The packet DMA circuitry of claim 26, wherein to transform the first packet descriptor to the second packet descriptor, the first descriptor ring control engine is to:
read, using the DMA engine, the first packet descriptor from a first packet descriptor ring, the first packet descriptor ring stored in the memory device;
identify the second descriptor format;
transform the first packet descriptor to the second packet descriptor, the first packet descriptor having the first packet descriptor format and the second packet descriptor having the second packet descriptor format; and
store, using the DMA engine, the second packet descriptor in a second packet descriptor ring.

31. The packet DMA circuitry of claim 30, wherein to read the first packet descriptor, the first descriptor ring control engine is to:
receive a notification of a descriptor to process;
identify the first packet descriptor ring associated with the descriptor to process; and
read, using the DMA engine, the first packet descriptor from the first packet descriptor ring.

32. The packet DMA circuitry of claim 30, wherein to identify the second packet descriptor format, the first descriptor ring control engine is to:
parse the first packet descriptor to obtain a memory address;
read, using the DMA engine, the packet data from the memory address;
parse the packet data to obtain a target network device; and
identify the second packet descriptor format based on the target network device.

33. The packet DMA circuitry of claim 30, wherein to transform the first packet descriptor to the second packet descriptor the first descriptor ring control engine is to rearrange contents of the first packet descriptor to have an arrangement compatible with the second packet descriptor format.

34. The packet DMA circuitry of claim 30, wherein the first descriptor ring control engine is to:
parse the first packet descriptor to obtain a source memory address in the memory device;
read, using the DMA engine, the packet data from the source memory address;
identify a target memory address;
copy, using the DMA engine, the packet data from the source memory address to the target memory address; and
store, using the DMA engine, the target memory address in the second packet descriptor.

35. The packet DMA circuitry of claim 26, wherein the first packet descriptor format is compatible with a first virtual network interface device.

36. The packet DMA circuitry of claim 35, wherein the second packet descriptor format is compatible with a second virtual network interface device.

37. The packet DMA circuitry of claim 26, wherein the first packet descriptor format is compatible with a physical network interface device.

38. The packet DMA circuitry of claim 37, wherein the second packet descriptor format is compatible with a second virtual network interface device.

39. The packet DMA circuitry of claim 26, wherein the first packet descriptor format is compatible with a virtual network interface device.

40. The packet DMA circuitry of claim 40, wherein the second packet descriptor format is compatible with a physical network interface device.

41. A method for packet descriptor handling performed at a hardware device, comprising:
reading from a memory device, using direct memory access (DMA), a source descriptor from a source descriptor ring, the source descriptor referring to a packet data and the source descriptor having a first descriptor format;
identifying a target descriptor format;
transforming the source descriptor to a target descriptor, the target descriptor referring to the packet data and having the target descriptor format; and
storing in the memory device, using DMA, the target descriptor in a target descriptor ring.

42. The method of claim 41, wherein reading the source descriptor comprises:
receiving a notification of a descriptor to process;
identifying the source descriptor ring associated with the descriptor to process; and
reading, using DMA, the source descriptor from the source descriptor ring.

43. The method of claim 41, wherein identifying the target descriptor format comprises:
parsing the source descriptor to obtain a memory address;
reading, using DMA, the packet data from the memory address;
parsing the packet data to obtain a target network device; and
identifying the target descriptor format based on the target network device.

44. At least one machine-readable medium including instructions for packet descriptor handling, which when executed by a hardware device, cause the hardware device to perform operations comprising
reading from a memory device, using direct memory access (DMA), a source descriptor from a source descriptor ring, the source descriptor referring to a packet data and the source descriptor having a first descriptor format;
identifying a target descriptor format;
transforming the source descriptor to a target descriptor, the target descriptor referring to the packet data and having the target descriptor format; and
storing in the memory device, using DMA, the target descriptor in a target descriptor ring.

45. The machine-readable medium of claim 44, wherein the instructions for reading the source descriptor comprise instructions for:
receiving a notification of a descriptor to process;
identifying the source descriptor ring associated with the descriptor to process; and
reading, using DMA, the source descriptor from the source descriptor ring.
